(19) United States
(12) Patent Application Publication
(10) Pub. No.: US 2006/0201354 A1
(43) Pub. Date: Sep. 14, 2006

(54) Stamp

(75) Inventor: Mitsunobu Suda, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/566,646

(22) PCT Filed: Sep. 21, 2004
(86) PCT No.: PCT/JP04/13726

§ 371 Date: Mar. 30, 2006

(30) Foreign Application Priority Data
Oct. 31, 2003 (JP) 2003373716

(51) Int. Cl. B41K 1/38

(52) U.S. Cl. 101/327

(57) ABSTRACT

This invention provides a stamp capable of matching a selectable print face and a fixed print face on a same plane easily. A damper member 300 is provided between a rear end 124 of a base portion 120 of a fixed print portion 100 and a collar 203 of a supporting case 201 of a movable print portion 200. A print face 111 of the fixed print portion 100 movable relative to a main body case 2 is projected from a print face 211 of the movable print portion 200 immovable relative to the main body case 2 in a stamping direction. At the time of stamping, the print face 111 makes contact with a stamping object ahead of the print face 211 and due to a reaction force from a stamping object, a damper member 300 softer than the fixed print member 112 is compressed more than the fixed print member 112. As a consequence, the print face 111 and the print face 211 are matched on a same plane on the surface of the stamping object 50 so that no unevenness occurs in a print image stamped by synthesizing the print face 111 with the print face 211.

### TECHNICAL FIELD

The present invention relates to a stamp capable of forming a print image by combining a selectable print face with a fixed print face.

### BACKGROUND ART

Conventionally, in a stamp capable of forming a print image by combining two or more print faces, if a deflection occurs in height between respective print faces, the respective print faces are not matched on a same level and in a print image pressed with that condition, partial unevenness is generated. For example, in case of a date stamp, unless the print face is adjusted appropriately, there is such a problem that date cannot be read from a print image. In such a date stamp, a print image is created by combining a print face selected from a rotary print body (movable print body) having a plurality of print faces (date portion) with a fixed print face (part of company name or the like) of the fixed print body.

According to the Patent document 1, the print face of a print belt (rotary print body) is urged in a direction of losing matching with the print face of a master print body (fixed print body) with an elastic member such as a leaf spring and by rotating an adjustment ring for moving the print face of the print belt (rotary print body) in a direction of matching with the print face of the master print body (fixed print body), both the print faces are matched to the same level.

Patent document 1: Japanese Patent Application Laid-Open No. 2000-318282

### DISCLOSURE OF THE INVENTION

Problem to be Solved by the Invention

However, the adjustment of the print face needs to be carried out before the stamp is pressed down. At that time, in order to confirm whether or not the adjustment of the print face is completed, it is necessary to repeat the adjustment of the print face and trial stamping, thereby taking time and labor.

The present invention has been made to solve the above-described problem and an object of the invention is to provide a stamp capable of matching the selectable print face and the fixed print face to the same level easily.

Means for Solving the Problem

To achieve the above-described object, the stamp of the present invention comprises: a first print face for forming a print image on a stamping object; a second print face for forming a print image on the stamping object by synthesizing with the print image of the print face of the first print face; and a damper member that presses the first print face so that the first print face in a stamping direction is projected more than the second print face in the stamping direction with elasticity at the time of no stamping and is compressed so that the first print face and the second print face are matched with each other with a reaction force applied to the first print face from the stamping object at the time of stamping.

A length over which the damper member is capable of stretching in the stamping direction when not compressed may be larger than a length over which the first print face is projected with respect to the second print face at the time of stamping.

The stamp of the present invention may further comprise: a movable print body fixed on a main body case and in which a plurality of the second print faces are provided protrudedly along the outside face of a belt supported movably; and a fixed print body provided movably in the stamping direction with respect to the main body case, having an exposure hole for exposing one of the second print faces of the movable print body out of the main body case and having the first print face for forming a single print image by synthesizing with a print image of the second print face exposed from the exposure hole and the damper member may be provided between the movable print body and the fixed print body such that it always keeps contact therewith.

The stamp of the present invention may further comprise: a movable print body provided movably in the stamping direction with respect to the main body case and in which a plurality of the first print faces are provided protrudedly along the outside face of a belt supported movably; and a fixed print body fixed on the main body case, having an exposure hole for exposing one of the first print faces of the movable print body out of the main body case and having the second print face for forming a print image by synthesizing with a print image of the first print face exposed from the exposure hole, and the damper member may be provided between the movable print body and the main body case such that it always keeps contact therewith.

The movable print body may have a collar having a plane parallel to a direction perpendicular to the stamping direction at a portion that the damper member makes contact with and the damper member may be constructed in a substantially same shape as the collar.

The main body case may be a cylindrical case, having a pair of bosses provided protrudedly in directions of opposing each other on the inside face on an end side, and the fixed print body may comprise: a base portion that engages the internal periphery on an end side of the main body case and has the print face on a cylindrical end side; and a spiral groove provided spirally in the outer periphery of the base portion, that the bosses engage to position the main body case and the base portion.

When the fixed print body engages the main body case, the relation between positions of the base portion and the main body case when the boss is located at a beginning end of the spiral groove and the positions of the base portion and the main body case when the boss is located at a final end of the spiral groove may be such that the rotation angle of the main body case with respect to the base portion is 90° or more to 270° or less.

The fixed print body may have a stopper for restricting the boss from moving in a direction to the beginning end along the spiral groove when the boss of the main body case is located at the final end of the spiral groove.

The movable print body may be accommodated in the main body case before the fixed print body and the main body case engage each other and the collar of the movable print body and the damper member may be provided with a cutout portion that prevents from interfering with the bosses.

Hardness of the damper member may be lower than the hardness of the first print face and the second print face.

Hardness of the damper member may be 20% or more to 80% or less the hardness of the first print face and the second print face.

Effect of the Invention

Because in the stamp of the present invention, the first print face and the second print face are matched with each other by the damper member at the time of stamping, even if adjustment for matching the print faces is not carried out beforehand at the time of no stamping, a beautiful print image without blur can be obtained at the time of stamping.

If the length over which the damper member can be stretched is set larger than the length over which the first print face is projected from the second print face, the first print face is supplied with a pressing force in the projection direction from the damper member at the time of no stamping as well, and because there is no play, there is no feeling of disharmony and no rattling occurs at the time of stamping.

If the movable print body is provided with the second print face and the fixed print body is provided with the first print face, a beautiful print image without blur can be obtained by synthesizing the respective print faces without any adjustment for matching the both faces.

If the movable print body is provided with the first print face and the fixed print body is provided with the second print face, a beautiful print image without blur can be obtained by synthesizing the respective print faces without any adjustment for matching the both faces.

Because if the damper member is substantially same shape as the collar, a pressing force can be applied to the entire plane of the collar from the movable print body, the pressing force never deflects partially, so that a stabilized pressing force can be applied. Further, because a mounting position of the damper member is determined depending on the shape at the time of assembly, the assembly is facilitated.

If the fixed print body and the main body case are engaged by the spiral groove, they approach each other gradually at the time of that engagement. Thus, no load such as a rapid twisting is applied to the damper member and consequently, the pressing force of the damper member is not affected.

If the main body case is to be rotated within a range of 90° or more to 270° or less with respect to the fixed print body when engaging the main body case with the fixed print body, the main body case can be rotated without re-gripping the main body case, thereby making it possible to reduce troubles at the time of assembly.

Further, although when the boss is located at the final end of the spiral groove, the boss tends to move toward the beginning end of the spiral groove receiving a pressing force from the damper member, the main body case and the fixed print body can be prevented from disengaging by restricting the stopper.

Further, if the cutout portion is provided, the boss never interferes with the collar and the damper member when the movable print body is accommodated in the main body case even if the main body case is not constructed in a large size.

If the hardness of the damper member is set lower than the hardness of the first print face and the second print face, the damper member is more likely to be compressed than the first print face and the second print face at the time of stamping, so that the first print face and the second print face are matched with each other thereby obtaining a beautiful print image without any blur.

If the hardness of the damper member is set to 20% or more to 80% or less the hardness of the first print face and the second print face, the damper member is more likely to be compressed than the first print face and the second print face at the time of stamping, so that the first print face and the second print face are matched with each other, thereby obtaining a beautiful print image without any blur.

### BRIEF DESCRIPTION OF THE DRAWINGS

FIG. 1 is a perspective view of a date stamp 1 in a condition enabling itself to be pressed down;

FIG. 2 is a perspective view of a date stamp 1 in a condition enabling its print face 211 to be changed;

FIG. 3 is a disassembly perspective view of the date stamp 1;

FIG. 4 is a perspective view of a holding body 230 holding a movable print member 210;

FIG. 5 is a sectional view of the date stamp 1 as seen along arrows A on a dot and dash line shown in FIG. 1;

FIG. 6 is a sectional view of the date stamp 1 as seen along arrows B on a dot and dash line shown in FIG. 1;

FIG. 7 is a perspective view of the date stamp 1 indicating a condition in which a damper member 300 is mounted on a collar 203;

FIG. 8 is a sectional view of the date stamp 1 as seen along arrows C on a dot and dash line shown in FIG. 2;

FIG. 9 is a sectional view of the date stamp 1 when pressed down;

FIG. 10 is a diagram showing a modification of the section of the date stamp 1; and

FIG. 11 is a diagram showing a modification of the section of the date stamp 1 when pressed down.

### BEST MODE FOR CARRYING OUT THE INVENTION

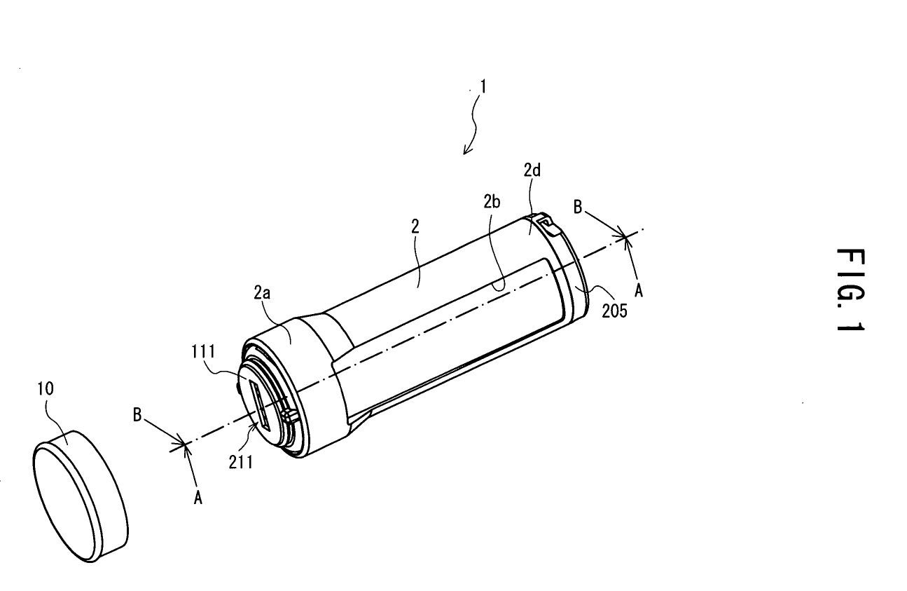

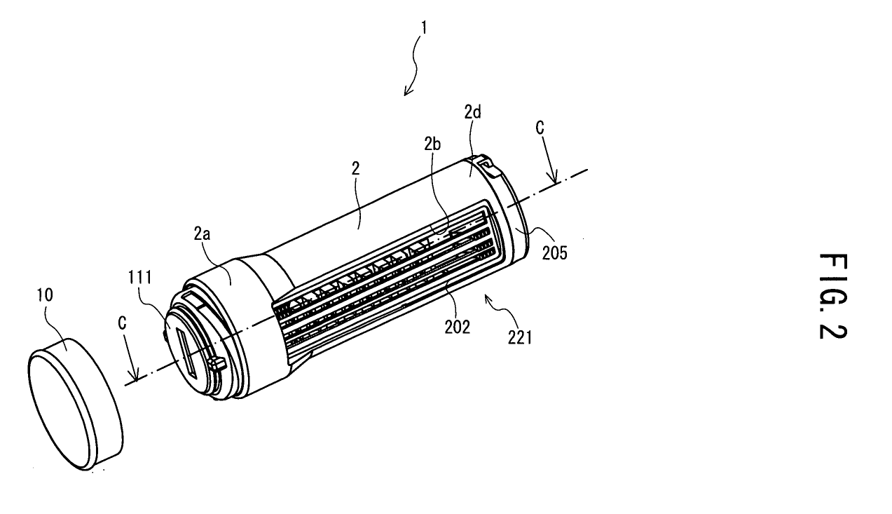

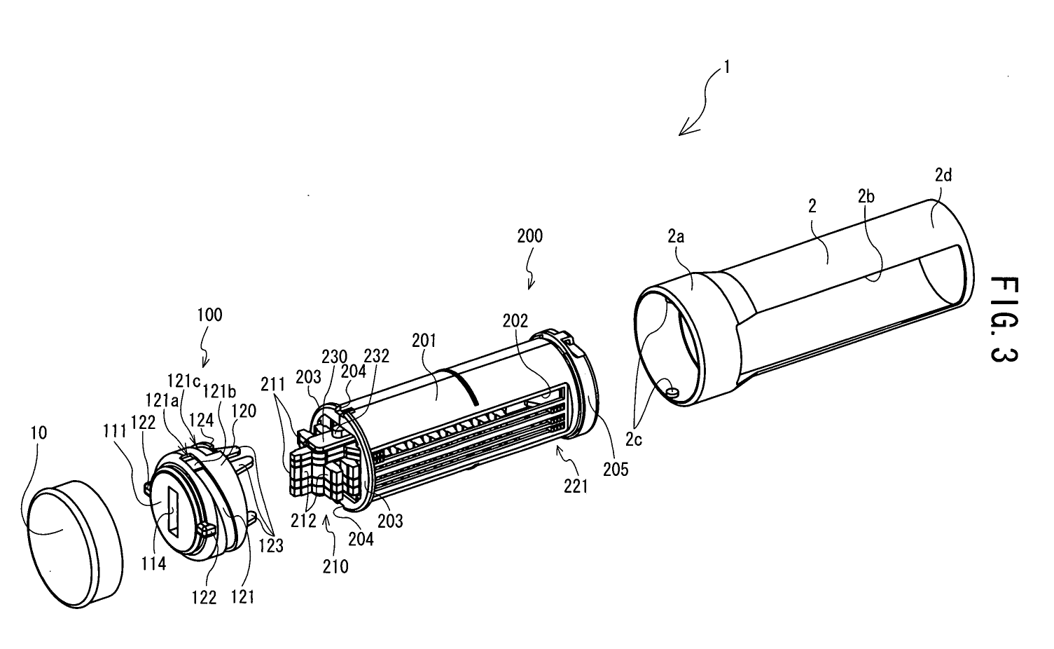

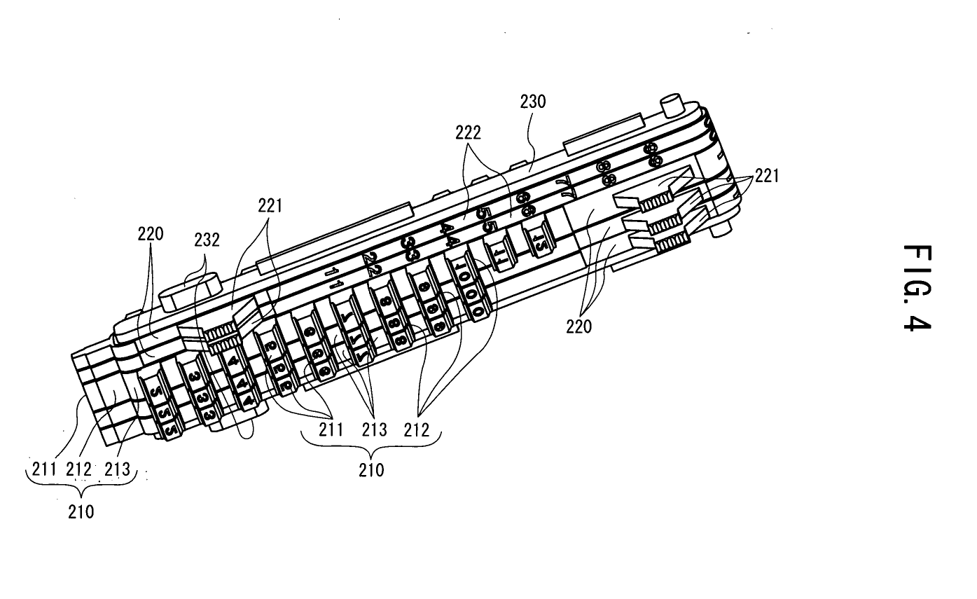

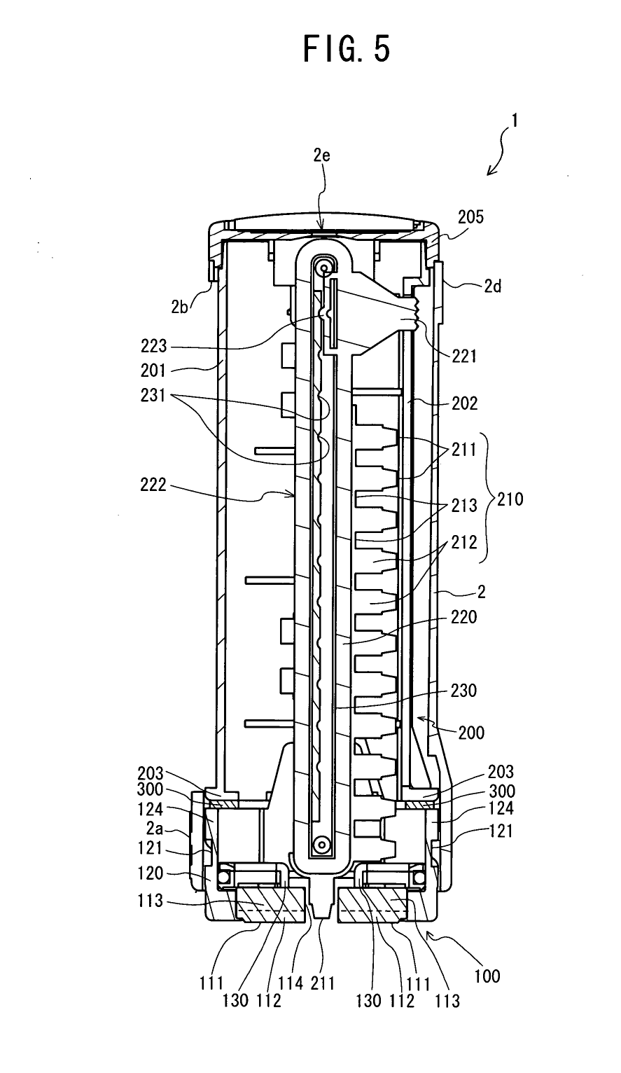

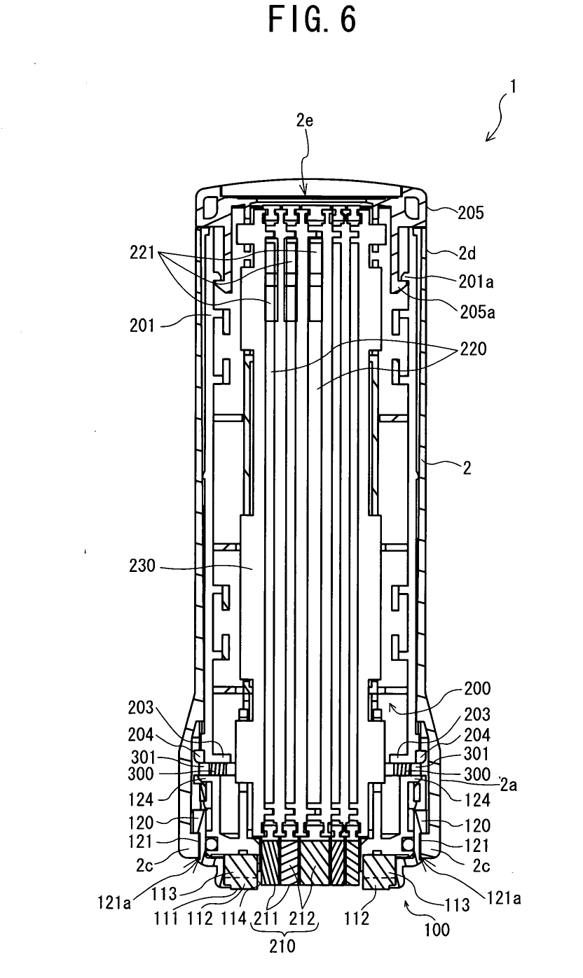

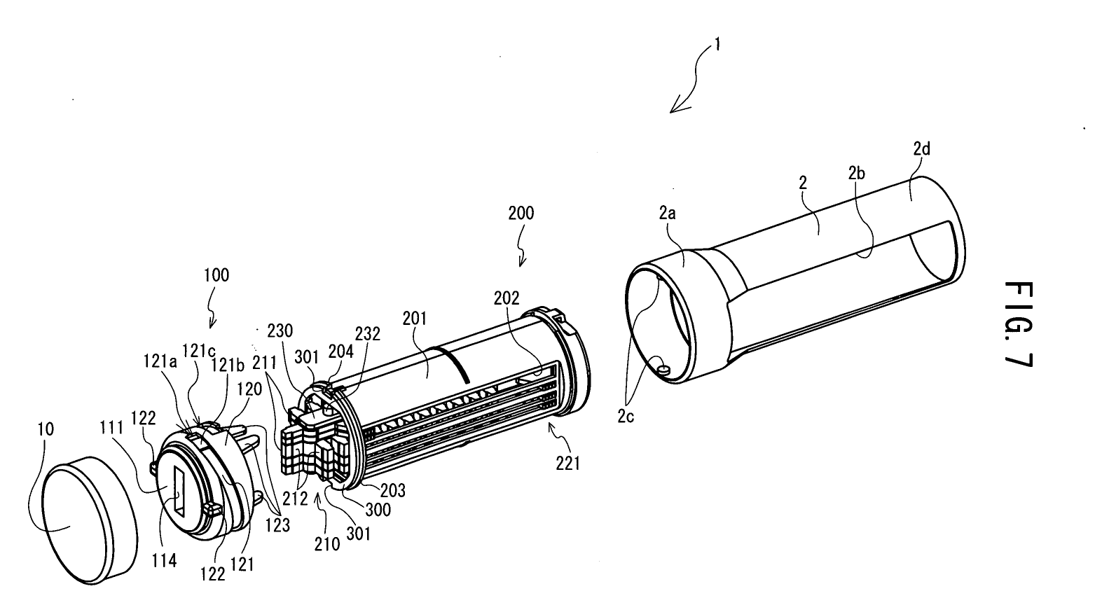

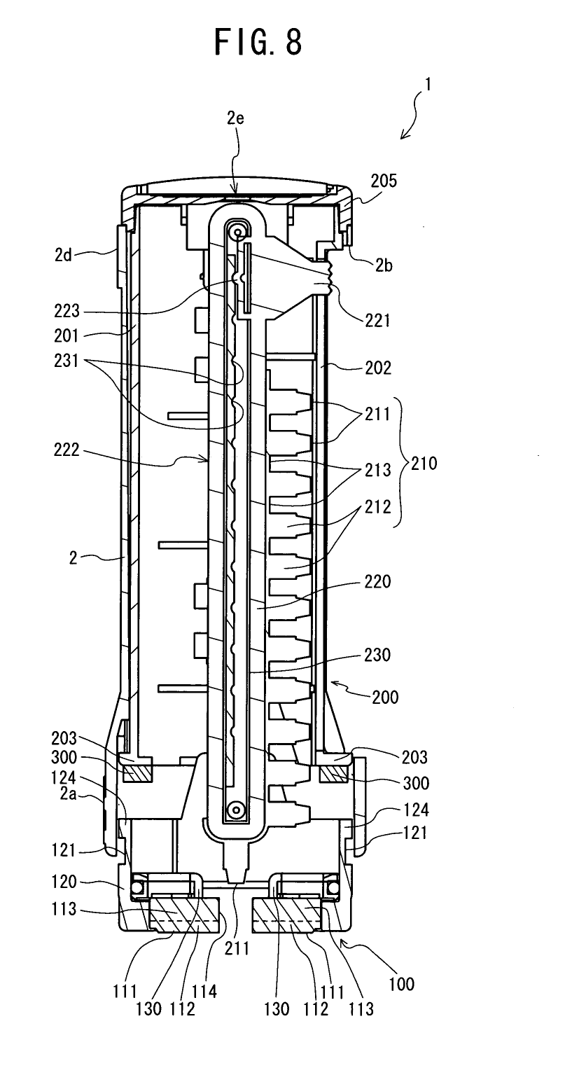

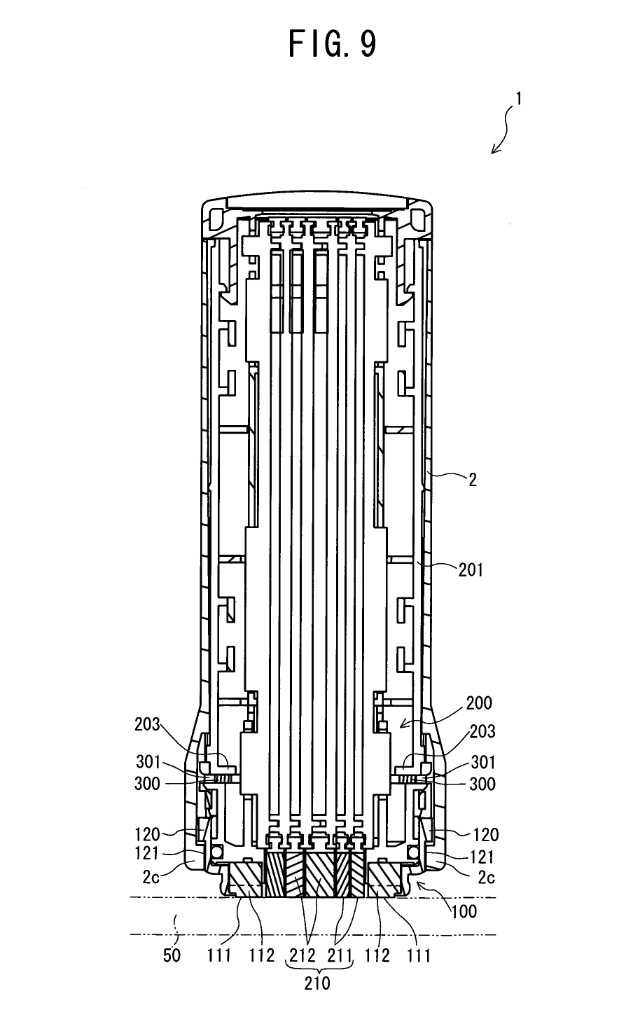

Hereinafter, an embodiment of the stamp of the present invention will be described about a date stamp 1 which is an example thereof. FIG. 1 is a perspective view of a date stamp 1 in a condition enabling itself to be pressed down. FIG. 2 is a perspective view of a date stamp 1 in a condition enabling its print face 211 to be changed. FIG. 3 is a disassembly perspective view of the date stamp 1. FIG. 4 is a perspective view of a holding body 230 holding a movable print member 210. FIG. 5 is a sectional view of the date stamp 1 as seen along arrows A on a dot and dash line shown in FIG. 1. FIG. 6 is a sectional view of the date stamp 1 as seen along arrows B on a dot and dash line shown in FIG. 1. FIG. 7 is a perspective view of the date stamp 1 indicating a condition in which a damper member 300 is mounted on a collar 203. FIG. 8 is a sectional view of the date stamp 1 as seen along arrows C on a dot and dash line shown in FIG. 2. FIG. 9 is a sectional view of the date stamp 1 when pressed down.

As shown in FIG. 1, the date stamp 1 has a substantially cylindrical main body case 2 and the bore of a cylinder end portion 2a on one side of the main body case 2 is formed slightly larger than the diameter of the body. A print face for forming a print image on a stamping object is provided on the cylinder end portion 2a. The print face is a substantially circular print face having a face perpendicular to the axial direction of the main body case 2 and constructed to form a single print image by synthesizing a print face 111 having an unchangeable print image and a print face 211 capable of forming an arbitrary print image such as date by combining numerals and symbols. A cap 10 for covering the print faces 111 and 211 for protection when the date stamp 1 is not used is provided on the main body case 2 so as to be attachable to or detachable from the cylinder end portion 2a.

A rear end portion 205 of a movable print portion 200 (see FIG. 3) is exposed from a cylinder end portion 2d on an opposite side to a cylinder end portion 2a of the main body case 2. If as shown in FIG. 2, with the main body case 2 held, the rear end portion 205 is rotated at substantially 180° in the circumferential direction to the main body case 2, the movable print portion 200 is rotated together with the rear end portion 205. As a consequence, a sliding type operation portion 221 is exposed through an opening portion 2b which is open to the outer peripheral face of the main body case 2. As described later, this operation portion 221 is provided for changing print faces 211 which are provided in plural kinds.

As shown in FIG. 3, a movable print portion 200 holding the print face 211 and a fixed print portion 100 holding a print face 111 are accommodated inside the main body case 2. The fixed print portion 100 comprises a fixed print member 112 (see FIG. 5) on which the print face 111 is formed, an ink storage body 113 (see FIG. 5) which makes a contact with the fixed print member 112 to supply ink, and a base portion 120 which holds the fixed print member 112 and the ink storage body 113 and is fit to an internal face of the cylinder end portion 2a of the main body case 2. Two spiral grooves 121 are provided in an outer face of the base portion 120 in order to close the opening of the cylinder end portion 2a with the fixed print portion 100 with the movable print portion 200 accommodated in the main body case 2. Two bosses 2c protruded from the internal face of the cylinder end portion 2a of the main body case 2 such that they oppose each other are engaged with this spiral groove 121. Meanwhile, the fixed print portion 100 corresponds to a “fixed print body” of the present invention.

A stopper 121b is provided at a final end 121a of the spiral groove 121 by swelling the bottom face of the spiral groove 121, so that when the fixed print portion 100 is advanced or retreated, the bosses 2c located at the final end 121a are restricted from moving in a direction along the spiral groove 121. Likewise, a similar stopper 121c is provided at a beginning end of the spiral groove 121 so that when the fixed print portion 100 is loosened, the bosses 2c are restricted from moving by the stopper 121c, thereby preventing the fixed print portion 100 from loosing out of the main body case 2 easily.

A rotation angle of the fixed print portion 100 to the main body case 2, which is rotated from a position where the boss 2c is located at the final end 121a of the spiral groove 121 and moved beyond the stopper 121b along the spiral groove 121 and restricted from moving by the stopper 121c, is set to substantially 180° according to this embodiment. This rotation angle is preferred to be at least 90° or more to 270° or less. This is because if the rotation angle of the fixed print portion 100 is less than 90°, the direction of the spiral groove 121 guiding the boss 2c approaches the moving direction of the fixed print portion 100 more so that when the fixed print portion 100 is rotated, resistance applied to the boss 2c making a sliding contact with the spiral groove 121 is increased. If the rotation angle is over 270°, when a user rotates the fixed print portion 100 by gripping the main body case 2, a necessity of re-gripping the main body case 2 or the fixed print portion 100 occurs.

Two pairs of guide members 123 are provided to project from the inside of the base portion 120 of the fixed print portion 100 in an opposite direction to the print face 111. Two guide pieces 232 projected on the side face in the short side direction of the holding body 230 of the movable print portion 200 described later are nipped between each pair of the guide members 123. Thus, the fixed print portion 100 is limited in its moving direction to the movable print portion 200 so that it is capable of sliding only in the axial direction. That is, if the boss 2c is slid along the spiral groove 121, the fixed print portion 100 is advanced or retreated in the axial direction with respect to the main body case 2.

A pair of protrusions 122 is provided on the side face of a holding portion for holding the fixed print member 112 and an ink storage body 113 of the base portion 120. These protrusions 122 engage engagement portions (not shown) provided inside the cap 10. A substantially rectangular exposure hole 114 is provided substantially in the center of the print face 111 of the fixed print portion 100 such that it passes through the fixed print portion 100 in a direction perpendicular to the surface of the print face 111. The exposure hole 114 is a hole for the print face 211 of the movable print member 210 to be exposed from the main body case 2. The aforementioned protrusions 122 are provided on the side face of the base portion 120 on both sides in the short side direction of the exposure hole 114.

Next, the movable print portion 200 supports the holding body 230 holding the movable print member 210 in its cylindrical supporting case 201. As shown in FIGS. 4 to 6, the movable print members 210 are fixed on the outer peripheral face of five belt bodies 220 supported in parallel such that they are capable of rotating individually along the length direction of the substantially rectangular plate-like holding body 230 and their positions are moved by rotating the belt bodies 220. As shown in FIGS. 4 and 5, the movable print members 210 are provided protrudedly on the outer peripheral face of the belt body 220 and a plurality of print portions 212 each having a print face 211 at its end are provided in line along the rotation direction of the belt body 220. Roots of the respective print portions 212 are connected with a connecting portion 213. The length of the movable print member 210 is less than half the belt body 220. The print portion 212 and the connecting portion 213 having the print face 211, constituting the movable print member 210 are formed integrally of, for example, ink impregnating body such as porous resin. Meanwhile, the movable print member 210 corresponds to a “movable print body” of the present invention.

The operation portion 221 is provided protrudedly on the outer peripheral face of the belt body 220, the operation portion 221 being operated when rotating the respective belt bodies 220 individually. By sliding the operation portion 221 along the length direction of the holding body 230, the belt body 220 can be rotated. Further, a sample 222 of a print image corresponding to the print face 211 of each print portion 212 is printed on the outer peripheral face on an opposite side to the outer peripheral face of the belt body 220 on which the movable print member 210 is fixed. When the operation portion 221 is operated so that any print portion 212 is located on the side face on one side in the length direction of the holding body 230 (side face on the bottom of the drawing in FIG. 5), the sample 222 of the print image corresponding to that print face 211 is located on the other side face (side face on the top side of the drawing in FIG. 5). A sample window 2e is opened in the bottom face of the rear end portion 205 of the movable print portion 200, so that a sample 222 located on the other side face in the length direction of the holding body 230 can be seen visibly through that sample window 2e.

As shown in FIG. 5, a convex portion 223 which is urged to be able to advance or retreat in a direction perpendicular to the sliding direction of the operation portion 221 is provided protrudedly on the operation portion 221 of the belt body 220. Concave portions 231 which position by engaging the convex portion 223 to give a load to a rotation of the belt body 220 are provided in the same quantity as the print portions 212 along the rotation direction of the belt body 220 inside the holding body 230. This configuration is for positioning the belt body 220 such that when the convex portion 223 engages the concave portion 231, the print portion 212 corresponding to that concave portion 231 is located on the side face of the holding body 230 in the length direction. The respective print portions 212 of the five belt bodies 220 positioned in this way are arranged in parallel and when the movable print portion 200 is accommodated in the main body case 2 and lidded with the fixed print portion 100, those print portions are inserted into the exposure hole 114 such that their parallel arrangement direction meets the length direction of the exposure hole 114. At this time, the guide members 123 of the fixed print portion 100 nip the guide piece 232 of the holding body 230 of the movable print portion 200 so that positioning of the fixed print portion 100 to the movable print portion 200 is carried out and thus, the parallel arrangement direction of the print portion 212 meets the length direction of the exposure hole 114.

As described above, the supporting case 201 shown in FIG. 3 is formed cylindrically corresponding to the internal face of the main body case 2 to be accommodated. At an end portion on the print face side of the supporting case 201 is provided a collar 203 surrounding the outer face thereof protrudedly in a direction perpendicular to the outer peripheral face, so that a plane parallel to the direction perpendicular to the axial direction of the main body case 2 for accommodating the supporting case 201 is formed. The outer periphery of the collar 203 is of almost the same size as the internal periphery of the cylinder end portion 2a of the main body case 2 which is larger than the body diameter. Further, cutout portions 204 are provided at two positions in the collar 203 to prevent the bosses 2c from interfering when the supporting case 201 is accommodated into the main body case 2. As described later, when the fixed print portion 100 and the movable print portion 200 are accommodated into the main body case 2, a damper member 300 formed in the shape of a ring substantially equal to the plane of the collar 203 is sandwiched between the fixed print portion 100 and the movable print portion 200.

Four narrow groove-like guide grooves 202 are opened along the axial direction in one side face of the supporting case 201. When the holding body 230 is accommodated in the supporting case 201, the respective operation portions 221 (see FIG. 4) of the five belt bodies 220 are protruded out of the supporting case 201 such that the operation portions 221 of two belt bodies 220 on the side of an end are protruded from the same groove 202 while the operation portions 221 of the remaining three belt bodies 220 are protruded from independent guide grooves 202. Further, when the supporting case 201 is accommodated in the main body case 2 as shown in FIG. 2 so that the movable print faces 211 can be changed, all the four guide grooves 202 are exposed from the opening portion 2b.

Next, as shown in FIGS. 5 and 6, the fixed print portion 100 holds the fixed print member 112 and the ink storage body 113 with the cylindrical base portion 120, such that the print face 111 of the fixed print member 112 is exposed to the front face. The ink storage body 113 is made of, for example, porous resin and capable of storing ink by impregnating its inside with ink. The fixed print member 112 is also made of porous resin and the print face 111 is compressed and exposed to light with portions turning to print image of the fixed print member 112 masked and the exposed portions are melted to clog its pores. The fixed print member 112 is supplied with ink from the ink storage body 113.

As shown in FIG. 5, on a face opposite to the face of the ink storage body 113 which makes contact with the fixed print body 112, an ink transmitting body 130 which makes contact with the print portion 212 of the movable print member 210 is provided such that it is in contact with the ink storage body 113. The ink transmitting body 130 is made of, for example, felt or other member and transmits ink impregnated in the ink storage body 113 of the fixed print portion 100 to the print portion 212 of the movable print member 210 making in contact with the ink transmitting body 130 using capillary action so as to supply ink. The ink transmitted by the ink transmitting portion 130 from the ink storage body 113 is dispersed entirely in the movable print member 210 made of ink impregnating material so that the ink is delivered to respective print portions 212.

As shown in FIG. 6, the damper member 300 is disposed between the fixed print portion 100 and the movable print portion 200. As described above, as shown in FIG. 3, the damper member 300 is formed in the shape of a ring of substantially same shape as the plane of the collar 203 provided at an end portion of the supporting case 201. As a consequence, the damper member 300 does not interfere with the holding body 230 holding the movable print member 210 which is supported within the supporting case 201. Further, two cutout portions 301 are provided corresponding to the two cutout portions 204 in the collar 203 in the damper member 300. If the damper member 300 is positioned with the cutout portions 301 in the damper member 300 meeting the cutout portions 204 in the collar 203 when the main body case 2 is assembled, the bosses 2c do not interfere when installing the supporting case 201 in the main body case 2.

When the supporting case 201 is accommodated in the main body case 2, it is held rotatably in the circumferential direction. At this time, because as shown in FIG. 6, the edge of the rear end portion 205 exposed through the cylinder end portion 2d of the main body case 2 makes a contact with the cylinder end portion 2d of the main body case 2, the supporting case 201 is restricted from moving in the direction to the cylinder end portion 2a of the main body case 2. Further, because the body diameter of the main body case 2 is smaller than that of the cylinder end portion 2a, the supporting case 201 is restricted from moving in the direction to the cylinder end portion 2d of the main body case 2 by the collar 203.

When assembling the date stamp 1 having such a configuration, first, as shown in FIG. 3, with the separable rear end portion 205 separated, the supporting case 201 is inserted into the main body case 2 through the cylinder end portion 2a of the main body case 2 and the rear end portion 205 is engaged with the supporting case 201 and fixed at the cylinder end portion 2d (as shown in FIG. 6, a hook 205a at the rear end portion 205 engages an engaging protrusion 201a provided protrudedly on the inside face of the supporting case 201 to fix the supporting case). Then, each of the two guide pieces 232 of the holding body 230 is let to be nipped between the pair of the guide members 123 of the fixed print portion 100 at the cylinder end portion 2a while a boss 2c of the main body case 2 are engaged with the spiral groove 121 of the fixed print portion 100 to install the fixed print portion 100. At a position where the boss 2c, after engaged with the spiral groove 121 from the beginning end, rides over the stopper 121c, as shown in FIG. 2, all the four guide grooves 202 are exposed from the opening portion 2b, so that as shown in FIG. 8, the selected print face 211 of the movable print member 210 is pulled out of the exposure hole 114 of the fixed print portion 100. If the operation portion 221 is operated under this condition, an arbitrary print face 211 can be selected.

Next, the bosses 2c are slid along the spiral groove 121 by rotating the fixed print portion 100. At this time, because the guide piece 232 is nipped by the guide members 123, when the fixed print portion 100 is rotated, the supporting case 201 is also rotated. Thus, this operation can be carried out by rotating the rear end portion 205 of the supporting case 201 with respect to the main body case 2. If the bosses 2c are guided by the spiral groove 121, as shown in FIG. 1, the fixed print portion 100 is moved in the direction of being accommodated into the main body case 2 and when the boss 2c rides over the stopper 121a of the spiral groove 121 and reaches the final end position, as shown in FIG. 5, the fixed print portion 100 is positioned with respect to the main body case 2.

When changing the print face 211, by rotating the rear end portion 205 with the main body case 2 gripped, the bosses 2c slide along the spiral groove 121 like when assembling the date stamp 1. As a consequence, as described previously, the fixed print portion 100 advances or retreats in the axial direction of the main body case 2. When the fixed print portion 100 is moved into a condition enabling stamping to be executed, because a direction in which the spiral groove 121 guides the bosses 2c is slanted to the advancement/retreat direction (axial direction of the main body case 2) of the fixed print portion 100, the fixed print portion 100 and the movable print portion 200 do not approach each other rapidly thereby relaxing a load applied to the damper member 300 sandwiched between the both.

By the way, there is not a wall face on the print face side at the final end 121a of the spiral groove 121. When the boss 2c is located at the final end 121a, a range in which the fixed print portion 100 is capable of moving in the axial direction of the cylindrical main body case 2 is to a position in which the boss 2c makes contact with the wall face of the spiral groove 121 in terms of the direction to the cylinder end portion 2a of the main body case 2 and to a position in which the rear end 124 of the base portion 120 makes contact with the collar 203 in terms of the direction to the cylinder end portion 2d of the main body case 2. As for the damper member 300, its thickness at the time when it is not compressed is constructed to be larger than the range in which the fixed print portion 100 is capable of moving. When the date stamp 1 is able to be pressed down, the damper member 300 always keeps contact with the rear end 124 of the base portion 120 of the fixed print portion 100 and the collar 203 of the movable print portion 200 while pressing both of them in a direction of pushing far away. As a result, when no stamping is done, the print face 111 of the fixed print portion 100 movable in the axial direction of the main body case 2 is projected more in a stamping direction than the print face 211 of the movable print member 210 supported by the supporting case 201 restricted from moving in the axial direction of the main body case 2. Further, because the fixed print portion 100 is pressed by the damper member 300, keeping a condition in which the boss 2c of the main body case 2 is kept in contact with the wall face of the spiral groove 121, the fixed print portion 100 is prevented from rattling.

This damper member 300 is formed of soft material having elasticity such as urethane foam and felt. Although as described previously, the fixed print member 112 and the movable print member 210 are formed of porous resin, the damper member 300 is preferred to have a hardness of 20% or more to 80% or less the hardness of the fixed print member 112 and the movable print member 210. However, it is necessary to set the thickness of the damper member 300 so that a difference in thickness (absorption dimension) between a maximum compression time of the damper member 300 and a non-compression time is larger than the movable range of the fixed print portion 100.

When the date stamp 1 is pressed down, with the main body case 2 gripped, its print face is pressed against a stamping object 50 as shown in FIG. 9. At this time, the print face 111 of the fixed print member 112 projected more than the print face 211 of the movable print member 210 makes contact with the stamping object 50 and the fixed print member 112 receives a reaction force of the stamping from the stamping object 50. Due to provision of such a difference in hardness, the damper member 300 softer than the fixed print member 112 absorbs much reaction force so that it is compressed more than the fixed print member 112. If the damper member 300 is compressed so that its thickness decreases, the fixed print portion 100 is moved in the direction to the cylinder end portion 2d of the main body case 2. Then, the print portion 212 of the movable print member 210 of the movable print portion 200 restricted from moving with respect to the main body case 2 is moved relatively in the direction of projecting from the exposure hole 114. As a result, the print face 111 of the fixed print member 112 and the print face 211 of the movable print member 210 are matched with each other on a same plane on the surface of the stamping object 50. That is, when a print image of the print face 111 and a print image of the print face 211 are formed on the stamping object 50, both the print face 111 and the print face 211 make contact with the stamping object 50 thereby producing no unevenness in print. Further, because the damper member 300 is of substantially the same shape as the collar 203 of the supporting case 201, a pressing force received from the rear end 124 of the base portion 120 of the fixed print portion 100 at the time of stamping is applied to the plane of the collar 203 equally and thus, the pressing force is never deflected partially, so that no unevenness occurs in a print image.

As described above, in the date stamp 1 of this embodiment, the damper member 300 is provided between the fixed print portion 100 and the movable print portion 200 and the print face 111 of the fixed print portion 100 is projected more than the print face 211 of the movable print portion 200 in the stamping direction. At the time of stamping, the print face 111 makes contact with the stamping object ahead of the print face 211 and the damper member 300 softer than the fixed print member 112 is compressed more largely than the fixed print member 112 by a reaction from the stamping object. As a result, the print face 111 and the print face 211 are matched with each other on the same plane on the surface of the stamping object 50, so that no unevenness occurs in a print image produced by synthesizing the print face 111 with the print face 211.

The damper member 300 is formed in substantially the same shape as the collar 203 of the supporting case 201 so that addition of the damper member 300 as the composition of the date stamp 1 never makes assembly of the date stamp 1 complicated. Further, because of the same shape, a pressing force received from the rear end 124 of the base portion 120 of the fixed print portion 100 at the time of stamping can be applied to the plane of the collar 203 uniformly and consequently, no partial deflection occurs in the pressing force thereby producing no unevenness in a print image.

Further, the bosses 2c of the main body case 2 engage the spiral groove 121 provided in the outer peripheral face of the base portion 120 of the fixed print portion 100, thereby enabling the fixed print portion 100 to advance or retreat. Thus, assembly of the components is easy and when this stamp is just in a condition enabling itself to be pressed down, the damper member 300 is unlikely to receive any load.

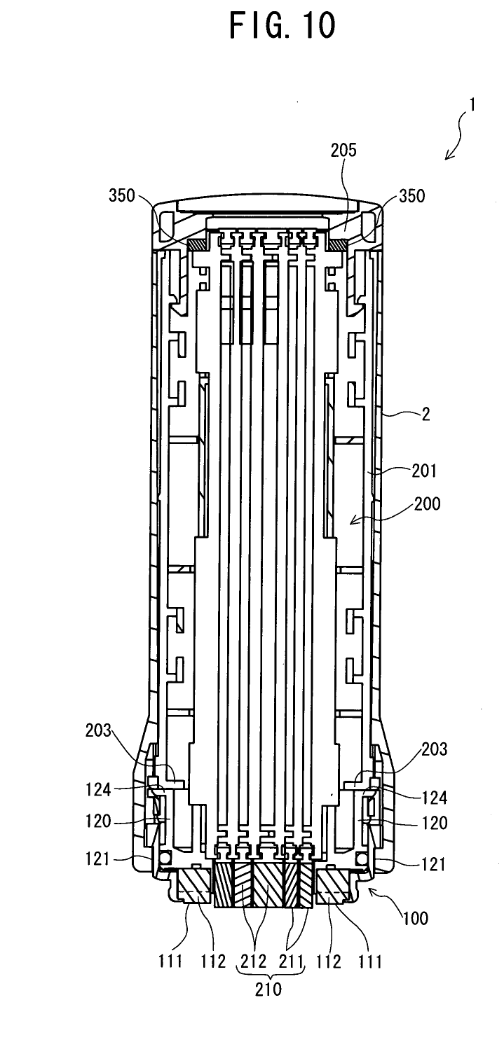

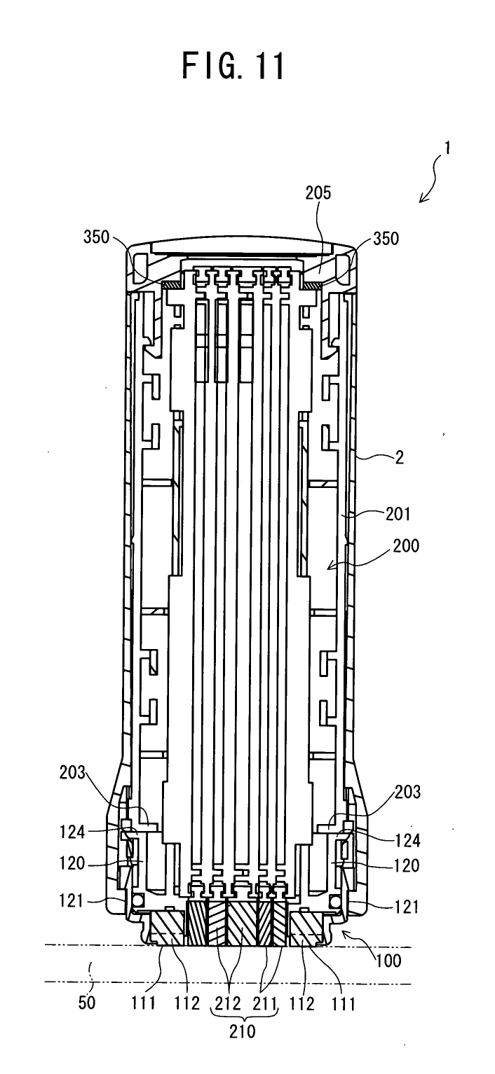

It is needless to say that the present invention can be modified in various ways. For example, although according to the above embodiment, the print face 211 and the print face 111 are matched with each other on the same plane by restricting moving of the movable print portion 200 with respect to the main body case 2 and moving the fixed print portion 100, the print faces may be matched by moving the movable print portion 200 while restricting moving of the fixed print portion 100 with respect to the main body case 2. Hereinafter, an example thereof is shown with reference to an accompanying drawing. FIG. 10 is a diagram showing a modification of the section of the date stamp 1. FIG. 11 is a diagram showing a modification of the section of the date stamp 1 when pressed down.

According to this modification, as shown in FIG. 10, no damper member is provided between the fixed print portion 100 and the movable print portion 200, but a damper member 350 is provided between a rear end portion 205 of the supporting case 201 and a holding body 230 supported within the supporting case 201. When the fixed print portion 100 is mounted on the main body case 2, the rear end 124 of the base portion 120 of the fixed print portion 100 is kept in contact with the collar 203 of the supporting case 201. Moving of the fixed print portion 100 in the direction to the cylinder end portion 2d of the main body case 2 along the axial direction of the main body case 2 is restricted by the collar 203 of the supporting case 201. Further, moving of the fixed print portion 100 in the direction to the cylinder end portion 2a of the main body case 2 along the axial direction of the main body case 2 is restricted by the wall face of the spiral groove 121.

On the other hand, like the above embodiment, the supporting case 201 is restricted from moving in the axial direction of the main body case 2. As regards the holding body 230 supported by the supporting case 201, its guide piece 232 is nipped by a pair of the guide members 123 of the fixed print portion 100 shown in FIG. 3. This paired guide members 123 (not shown) are formed in the shape of letter U and if the guide piece 232 makes contact with its crotch, moving of the holding body 230 in the direction to the cylinder end portion 2a of the main body case 2 along the axial direction of the main body case 2 is restricted. Moving of the holding body 230 in the direction to the cylinder end portion 2d of the main body case 2 along the axial direction of the main body case 2 is restricted by the corner of the holding body 203 making contact with a rib inside the rear end 124. The damper member 350 is provided at this position, always pressing the holding body 230 in the direction to the cylinder end portion 2a.

As a consequence, the print face 211 of the movable print member 210 held by the holding body 230 is projected from the print face 111 of the fixed print portion 100. Then, as shown in FIG. 11, when the date stamp 1 is pressed down, the print face 211 of the movable print member 210 makes contact with the stamping object 50 ahead, so that the damper member 350 is compressed like this embodiment and the print face 111 of the fixed print member 112 and the print face 211 of the movable print member 210 are matched with each other on the same plane on the surface of the stamping object 50.

Although there are provided five belt bodies 220 each having the movable print member 210 in parallel to each other, the quantity of the belt bodies may be two, three, six or more and it is not restricted to five. Although the movable print member 210 is provided such that it is fixed on the belt body 220, the movable print member 210 may be constructed into the shape of a belt. Further, the belt body 220 does not have to be an endless belt and in this case, the moving direction of the belt body 220 is guided by the holding body 230.

Although the movable print member 210 is formed of porous resin, the present invention is not restricted to this example but porous rubber, metal, ceramic and the like may be used and the material of the damper member 300 or 350 is determined such that its hardness is 20% to 80% the hardness thereof. Although according to the above embodiment, two print faces are combined, if three or more print faces are combined, it is permissible to fix one of those print faces and adjust the other print faces with the damper member to match those print faces on the same plane.

Further, the movable print member 210 may be replaceable and combined with the print face 111 of the fixed print portion 100 to produce a single print face. The exposure hole 114 for exposing the print portion 212 of the movable print member 210 is not restricted to any hole but may be a cutout or the like and any construction is permitted as long as the side faces of the fixed print member 112 and the ink storage body 113 oppose the print portion 212.

Although the shape of the damper member 300 is formed in substantially the same one as that of the collar 203 of the supporting case 201, for example, if there is no increase in its volume even if the damper 300 is compressed, or if there is provided a sufficient distance for the damper member 300 stretched in the right and left direction due to compression in the vertical direction not to contact the inside wall of the main body case 2, the damper member 300 and the collar 203 may be formed in the same shape.

### INDUSTRIAL APPLICABILITY

The present invention is applicable to a rotary type or sliding type date stamp, number stamp, address stamp and the like.

1-11. (canceled)

12. A stamp comprising:
a first print face for forming a print image on a stamping object;
a second print face for forming a print image on said stamping object by synthesizing with the print image of said first print face; and
a damper member that presses said first print face so that said first print face in a stamping direction is projected more than said second print face in the stamping direction with elasticity at the time of no stamping and is compressed so that said first print face and said second print face are matched with each other with a reaction force applied to said first print face from said stamping object at the time of stamping.

13. The stamp according to claim 12 wherein a length over which said damper member is capable of stretching in the stamping direction when not compressed is larger than a length over which said first print face is projected with respect to said second print face at the time of no stamping.

14. The stamp according to claim 13 further comprising:
a movable print body fixed on a main body case and in which a plurality of said second print faces are provided protrudedly along the outside face of a belt supported movably; and
a fixed print body provided movably in the stamping direction with respect to the main body case, having an exposure hole for exposing one of said second print faces of said movable print body out of the main body case and having said first print face for forming a single print image by synthesizing with a print image of said second print face exposed from the exposure hole, wherein
said damper member is provided between said movable print body and said fixed print body such that it always keeps contact therewith.

15. The stamp according to claim 14 wherein said movable print body has a collar having a plane parallel to a direction perpendicular to the stamping direction at a portion that
said damper member makes contact with and
said damper member is constructed in a substantially same shape as said collar.

16. The stamp according to claim 14 wherein said main body case is a cylindrical case, having a pair of bosses provided protrudedly in directions of opposing each other on the inside face on an end side and said fixed print body comprises:
a base portion that engages the internal periphery on an end side of said main body case and has said print face on a cylindrical end side; and
a spiral groove provided spirally in the outer periphery of the base portion so that said bosses engage to position said main body case and said base portion.

17. The stamp according to claim 13 further comprising:
a movable print body provided movably in the stamping direction with respect to the main body case and in which a plurality of said first print faces are provided protrudedly along the outside face of a belt supported movably; and
a fixed print body fixed on the main body case, having an exposure hole for exposing one of said first print faces of said movable print body out of the main body case and having said second print face for forming a print image by synthesizing with a print image of said first print face exposed from the exposure hole, wherein
said damper member is provided between said movable print body and said main body case such that it always keeps contact therewith.

18. The stamp according to claim 17 wherein said main body case is a cylindrical case, having a pair of bosses provided protrudedly in directions of opposing each other on the inside face on an end side and said fixed print body comprises:
a base portion that engages the internal periphery on an end side of said main body case and has said print face on a cylindrical end side; and
a spiral groove provided spirally in the outer periphery of the base portion so that said bosses engage to position said main body case and said base portion.

19. The stamp according to claim 12 further comprising:
a movable print body fixed on a main body case and in which a plurality of said second print faces are provided protrudedly along the outside face of a belt supported movably; and
a fixed print body provided movably in the stamping direction with respect to the main body case, having an exposure hole for exposing one of said second print faces of said movable print body out of the main body case and having said first print face for forming a single print image by synthesizing with a print image of said second print face exposed from the exposure hole, wherein
said damper member is provided between said movable print body and said fixed print body such that it always keeps contact therewith.

20. The stamp according to claim 19 wherein said movable print body has a collar having a plane parallel to a direction perpendicular to the stamping direction at a portion that
said damper member makes contact with and
said damper member is constructed in a substantially same shape as said collar.

21. The stamp according to claim 19 wherein said main body case is a cylindrical case, having a pair of bosses provided protrudedly in directions of opposing each other on the inside face on an end side and said fixed print body comprises:
a base portion that engages the internal periphery on an end side of said main body case and has said print face on a cylindrical end side; and
a spiral groove provided spirally in the outer periphery of the base portion so that said bosses engage to position said main body case and said base portion.

22. The stamp according to claim 12 further comprising:
a movable print body provided movably in the stamping direction with respect to the main body case and in which a plurality of said first print faces are provided protrudedly along the outside face of a belt supported movably; and
a fixed print body fixed on the main body case, having an exposure hole for exposing one of said first print faces of said movable print body out of the main body case and having said second print face for forming a print image by synthesizing with a print image of said first print face exposed from the exposure hole, wherein
said damper member is provided between said movable print body and said main body case such that it always keeps contact therewith.

23. The stamp according to claim 22 wherein said main body case is a cylindrical case, having a pair of bosses provided protrudedly in directions of opposing each other on the inside face on an end side and said fixed print body comprises:
a base portion that engages the internal periphery oh an end side of said main body case and has said print face on a cylindrical end side; and
a spiral groove provided spirally in the outer periphery of the base portion so that said bosses engage to position said main body case and said base portion.

24. The stamp according to claim 12 wherein said main body case is a cylindrical case, having a pair of bosses provided protrudedly in directions of opposing each other on the inside face on an end side and said fixed print body comprises:
a base portion that engages the internal periphery on an end side of said main body case and has said print face on a cylindrical end side; and
a spiral groove provided spirally in the outer periphery of the base portion so that said bosses engage to position said main body case and said base portion.

25. The stamp according to claim 24 wherein when said fixed print body engages said main body case, the relation between positions of said base portion and said main body case when said boss is located at a beginning end of said spiral groove and the positions of said base portion and said main body case when said boss is located at a final end of said spiral groove is such that the rotation angle of said main body case with respect to said base portion is 90° or more to 270° or less.

26. The stamp according to claim 24 wherein said fixed print body has a stopper for restricting said boss from moving in a direction to the beginning end along said spiral groove when said boss of said main body case is located at the final end of said spiral groove.

27. The stamp according to claim 24 wherein said movable print body is accommodated in said main body case before said fixed print body and said main body case engage each other and
said collar of said movable print body and said damper member are provided with a cutout portion that prevents from interfering with said bosses.

28. The stamp according to claim 12 wherein hardness of said damper member is lower than the hardness of said first print face and said second print face.

29. The stamp according to claim 28 wherein hardness of said damper member is 20% or more to 80% or less the hardness of said first print face and said second print face.
